(19) United States
(12) Patent Application Publication
(10) Pub. No.: US 2008/0320052 A1
(43) Pub. Date: Dec. 25, 2008

(54) Method and a computer program for inode allocation and De-Allocation

(75) Inventors: Aravinda Chandrachari, Bangalore (IN); Amarish Shapur Venkateshappa, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Company, L.P., Houston, TX (US)

(21) Appl. No.: 12/145,923

(22) Filed: Jun. 25, 2008

(30) Foreign Application Priority Data
Jun. 25, 2007 (IN) 1352/CHE/2007

(51) Int. Cl. G06F 12/02

(52) U.S. Cl. 707/200; 711/E12.002

(57) ABSTRACT

The present disclosure relates to a method and computer program for allocating inodes in a computing file system. The method, in one embodiment, includes determining whether all inodes in a first inode table have been initialized. Responsive to determining that all inodes in the first inode table have been initialized, a further inode table is created allocating additional inodes.

### RELATED APPLICATIONS

This patent application claims priority to Indian patent application serial number 1352/CHE/2007, having title “A Method and a Computer Program for Inode Allocation and De-Allocation”, filed on 25 Jun. 2007 in India (IN), commonly assigned herewith, and hereby incorporated by reference.

### BACKGROUND OF THE INVENTION

Inodes are data structures which are utilised by many file systems to store basic meta-data about a file, directory, or other file system object. Examples of file systems which utilise inodes include the UNIX File System (UFS), Veritas File System (VxFS) and the EXT2 File System, among others.

Inodes are pre-allocated and pre-initialized in an inode table during file system creation. The file system calculates the number of inodes that are to be provided in the inode table by using an algorithm which considers the size of the file system partition and the average file size. The file system then stores the inodes at a fixed offset in a contiguous block of disk space (i.e. the inode table), which is disparate to the portion of disk space used for storing actual data. In UNIX file systems, inodes are stored in the inode table in sequential order, to allow the inodes to be fetched directly using the inode number as the offset. That is, there is a direct mapping of the inode number to the disk block address of the inode (i.e. location of inode in the inode table).

The number of inodes in the inode table can neither be increased nor decreased once the File System has been created. That is, the inode table is fixed. File systems often include applications which are programmed to store many small files which may ultimately utilise all available inodes in the inode table, thereby preventing other applications from storing further files even if there is available disk space. In the alternative, the file system may pre-allocate too many inodes; resulting in the file system performing unnecessary processing operations during file system creation. This is particularly the case for file systems having resident applications which store small numbers of large files.

### BRIEF DESCRIPTION OF THE DRAWINGS

In order that the invention may be more clearly ascertained, embodiments will now be described, by way of example, with reference to the accompanying to drawings, in which;

FIG. 1 is a schematic view of a computing system according to an embodiment of the present invention.

FIG. 2 is a block diagram of a server, in which embodiments of the present invention may be implemented.

FIG. 3 is a block diagram illustrating a conventional UNIX file system disk layout for a first cylinder group.

FIG. 4 is a flow diagram illustrating a method for allocating inodes, according to an embodiment of the present invention.

FIG. 5 is a block diagram illustrating allocation of inodes on a hard disk of the server shown in FIG. 2, in accordance with an embodiment of the present invention.

FIG. 6 is a schematic of an inode map, in accordance with the present invention.

### DETAILED DESCRIPTION OF THE EMBODIMENTS

There will be provided a method and computer program for allocating and de-allocating inodes in a computing file system.

In one embodiment, the method of allocating inodes comprises the steps of determining whether all inodes in a first inode table provided on the computing file system have been initialized and, responsive to determining that all inodes in the first inode table have been initialized, creating a further inode table allocating additional inodes.

In another embodiment, there is provided a computer program comprising at least one instruction which, when implemented on a computer readable medium of a computing system, causes the computing system to implement the inode allocation method steps described above.

In another embodiment, there is provided a method of de-allocating inodes in a computing file system including at least a first and further inode table, comprising the steps of determining whether the further inode tables contains no initialized inodes; and responsive to determining that the further table contains no initialized inodes, deleting the further inode table.

In another embodiment, there is provided a computer program comprising at least one instruction which, when implemented on a computer readable medium of a computing system, causes the computing system to implement the inode de-allocation method steps described above.

In the context of the specification, the phrase “inode table” is to include within its scope any table which can be stored in any suitable disk space and which includes at least one inode which can be either initialized or de-initialized.

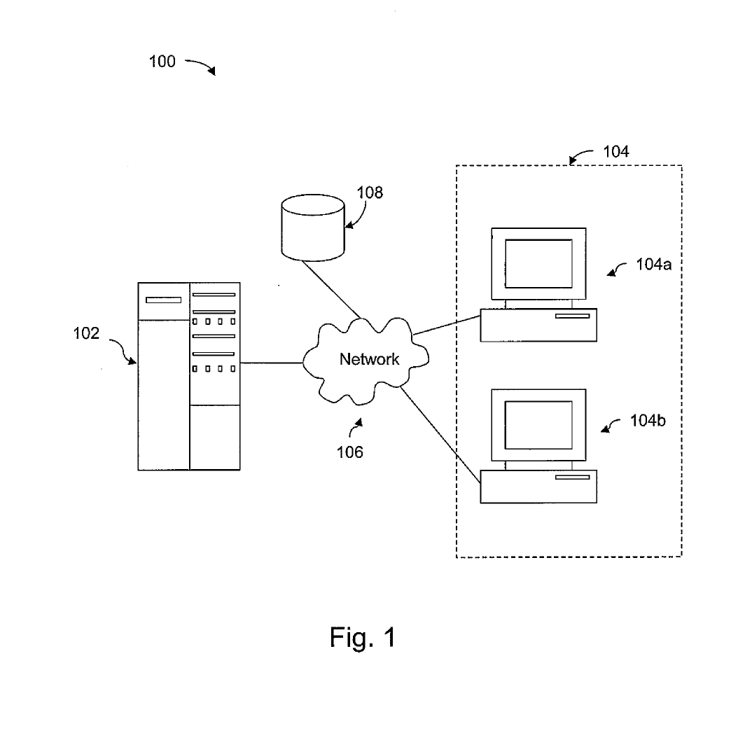

There will also be provided a computing system, such as the client-server computing system 100 illustrated in FIG. 1, which is configured to implement the above-described methods. In one embodiment, the client-server computing system 100 comprises a server 102 which is connected to clients 104, via a network in the form of the Internet 106. Clients 104 are in the form of personal computing devices 104a, 104b comprising standard hardware and software for communicating with the server 102. The clients 104 communicate with the server 102 using the Transmission Control Protocol/Internet Protocol (TCP/IP) suite of protocols. A storage device 108 is also connected to the network 106.

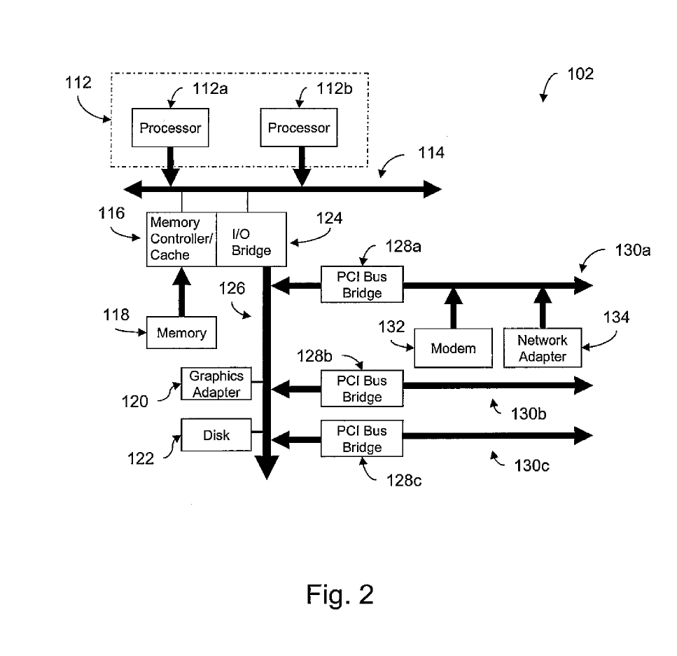

With reference to FIG. 2, there is shown a block diagram of the hardware and software for the server 102, which in accordance with the described embodiment is in the form of a HP-UX rx5670 server, available from the Hewlett Packard Company. The server 102 runs an operating system in the form of a UNIX operating system 132 with a UNIX stack. It should be noted that, although in this embodiment the server 102 implements a UNIX operating system 132, other embodiments may include different operating systems such as, for example, the LINUX operating system.

The UNIX operating system also includes a file system in the form of a Unix File System (UFS). The UFS is composed of a collection of cylinder groups and includes software for controlling the transfer of data between the network 106 and hard disk 122. A buffer cache composed of part of memory 118 is used as a buffer for this data transfer. The buffer cache is also arranged to hold contents of disk blocks for the purpose of reducing frequent high latency disk I/Os.

The server 102 further includes a number of processors 112 in the form of quad Intel Itanium 2 processors 112a, 112b (available from the Intel Corporation of The United States of America, http://.www.intel.com) coupled to a system bus 114. A memory controller/cache 116 is also coupled to the system bus 114 and is arranged to interface the memory 118, which is in the form of double data rate DDR SDRAM. Also provided is a graphics adapter 120 for handling high speed graphic addressing and an ATA gigabyte hard disk 122 which are connected to an I/O bus bridge 124, by way of an I/O bus 126. The memory controller 116 and I/O bus bridge may be interconnected, as shown in FIG. 2.

Connected to the I/O bus 126 are PCI bus bridges 128a, 128b, 128c, which provide an interface to devices connected to the server 102 via PCI buses 130a, 130b, 130c. A modem 132 and network adapter 134 are coupled to PCI bus 130a. The network adapter 134 is configured to allow the server 102 to exchange data with clients 104 using the TCP/IP protocol. As will be appreciated by person skilled in the art, additional I/O devices such as a CD-ROM, may also be coupled to the server 102 via I/O busses 130a, 130b, 130c.

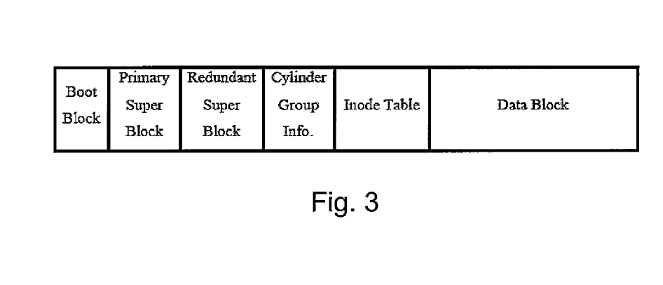

As discussed above, the UFS divides the hard disk 122 of the server 102 into multiple cylinder groups. In a conventional UFS disk layout, each cylinder group is composed of a backup copy of a file system superblock, a group header (which includes statistics, free lists, and other information describing the cylinder group), and an inode table comprising a fixed number of pre-allocated and pre-initialized inodes. The size of the inode table is calculated based on the size of the file partition and the average file size, during file system creation (i.e. when the command mkfs is invoked in the UFS operating system). A conventional cylinder disk layout is illustrated in FIG. 3.

Embodiments of the present invention utilise a dynamic inode allocation method which allocates additional inodes (typically in blocks, referred to as further or additional inode tables), as required by the file system. As additional inodes may be allocated after the initial file system creation, the number of inodes initially allocated may be significantly less than required by conventional file systems. The methodology is also capable of de-allocating inodes where the file system no longer has a need for the number of inodes currently allocated.

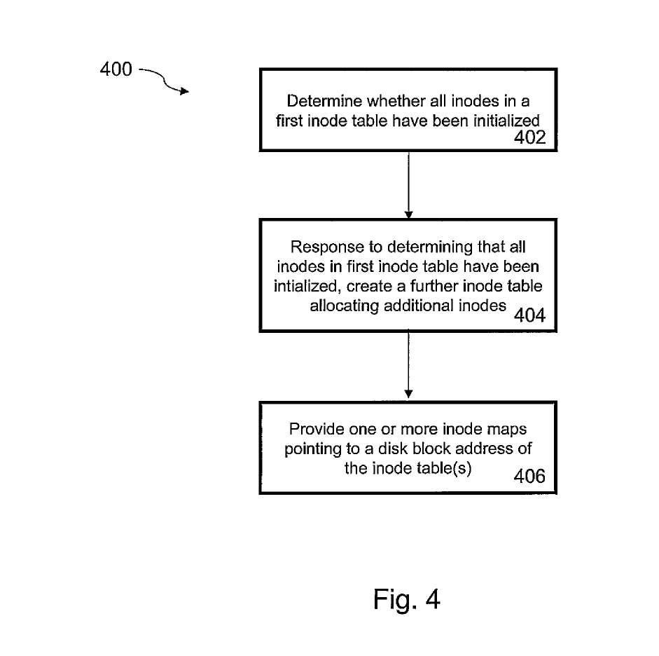

With reference to the flow diagram of FIG. 4, an inode allocation method for a computing file system including a first inode table, will now be described in accordance with an embodiment of the present invention. In the described embodiment, the first inode table is created at the time of creating the file system and inodes in the first inode table are initialized as required by the resident applications. At step 402, a determination is made as to whether all inodes in the first inode table have been initialized. If, at step 404, it is determined that the number of inodes required by the file system exceeds the capacity of the first inode table (i.e. all inodes in the first inode table have been initialized), a further inode table is created allocating additional inodes. It will readily be understood that any number of further/additional inode tables can be created in this manner and stored any suitable disk location, dependent only on the amount of available disk space, as will be described in more detail in subsequent paragraphs.

In order to allow resident applications to locate a desired inode, at step 406, a data structure in the form of an inode map (hereafter termed “alloc_map”) is created. The alloc_map is effectively an array of disk block addresses which point to successive inode tables (hereafter “inode_chunks”). FIG. 6 illustrates a typical structure for an alloc_map. As shown, the nth entry in the alloc_map points to an inode_chunk which contains the inodes numbered from (n*inodechunksize) to (((n+1)*inodechunksize)−1). However, using just one map would restrict the inodes to (allocmapsize)*(inodechunksize). As such further alloc_maps may be created, where required, so as to reference all allocated inodes. The disk space required for the extended alloc_maps or inode_chunks need not be pre-reserved by the file system.

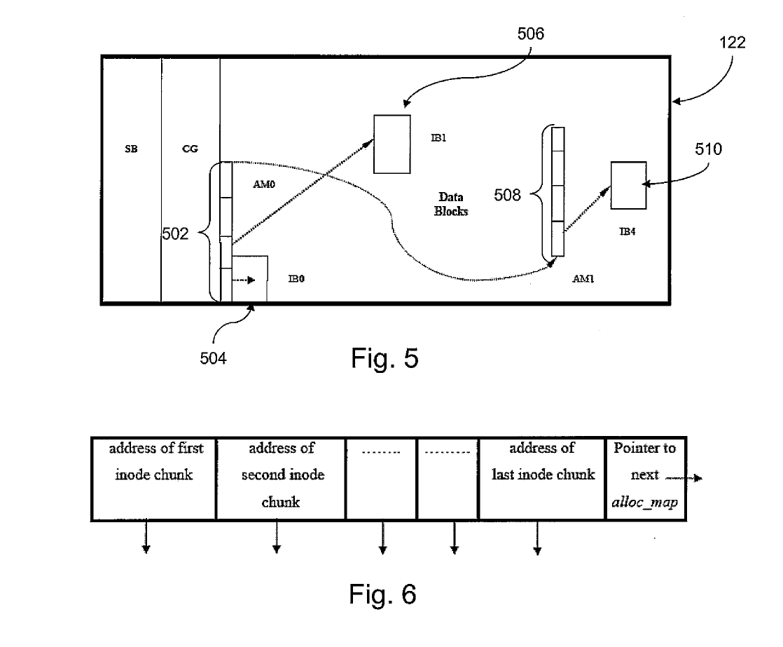

FIG. 5 illustrates the above-described method in more detail. For simplicity, the methodology described with reference to FIG. 5 provides that each alloc_map is arranged to point to the disk address of four inode_chunks. During file system creation, only the first alloc_map 502 and the first inode_chunk 504 are allocated. As illustrated, the first entry in alloc_map 502 points to the first inode_chunk 504. When the number of inodes exceeds the capacity of the first inode_chunk 504, a further inode_chunk 506 is allocated. Similarly, when the capacity of the alloc_map 502 is exceeded (in this case when a further inode-chunk 510 has been allocated), a new alloc_map 508 is allocated and linked to the previous alloc_map 502.

An example of pseudo computer programmable code which may be used to retrieve inodes using the methodology outlined above is provided below.

```
IGET (inode_number) : returns inode
{
  inode_chunk_number = inode_number / chunksize
  alloc_map_number = inode_chunk_number / allocmapsize
  if (alloc_map corresponding to alloc_map_number does not exist)
  {
    Allocate a new alloc_map of size allocmapsize
    Initialize the entries of alloc_map properly
    Link this alloc_map to pervious and next alloc_maps
  }
  if (inode_chunk corresponding to inode_chunk_number does
  not exist)
  {
    Allocate an inode_chunk of size chunksize
    Initialize the (inode_chunk_number % allocmapsize)th
    entry in the alloc_map to the starting address of this
    inode_chunk
  }
  Get the starting address of the inode_chunk from the alloc_map (at
  the offset ( inode_chunk_number % allocmapsize )
  Fetch the required inode from the inode_chunk at the offset
  (inode_number % chunksize) and return this inode.
}
```

Equation 1 below is used to determine the total time for fetching an inode using the above-described method. As will be shown, this data can then be utilised by the file system to establish the most appropriate inode_chunk and alloc_map size.

T=T_{ca}+T_{ci}+Tₛₐ+Tₐₐ+Tᵢₐ+T_{sic}+Tₐᵢ+Tᵢᵢ+Tₛᵢ (Equation 1)

where:
T_{ca}=Time to compute the alloc_map number
T_{ci}=Time to compute the inode_chunk number
Tₛₐ=Time to search and fetch the required alloc_map
Tₐₐ=Time to allocate a new alloc_map
Tᵢₐ=Time to initialize the alloc_map
T_{sic}=Time to search and fetch the required inode_map
Tₐᵢ=Time to allocate a new inode_chunk
Tᵢᵢ=Time to initialize the inode_chunk
Tₛᵢ=Time to search and fetch the required inode from the inode_chunk

In Equation 1, T_{ca} and T_{ci} are both constant times (i.e. no disk access is required) and can therefore be represented by K_{ca} and K_{ci}, respectively. Also, the allocation and initialization of a new disk block (for alloc_map and inode_chunk) needs only one disk access each for updating the super block (which can also be avoided by modifying only the “in memory” copy of the super block). Therefore, these times (i.e. Tₐₐ, Tᵢₐ, Tₐᵢ and Tᵢᵢ) can be represented by constants Kₐₐ, Kᵢₐ, Kₐᵢ and Kᵢᵢ, respectively. The step of searching for alloc_map is directly proportional to the number of alloc_maps. If n is the number of alloc_maps in the file system, then the process of searching for alloc_map needs n disk accesses. That is, Tₛₐ=n*Kₛₐ, where Kₛₐ is a constant representing the time required to fetch one alloc_map. Then T_{sic} and Tₛᵢ are again constant time operations (as shown in the algorithm). Let these be represented by K_{sic} and Kₛᵢ respectively.

Therefore, the total time required by the algorithm is:

$$\begin{matrix}T = ( {T}_{ca} + {T}_{ci} ) + ( {T}_{sic} + {T}_{ci} ) + ( {T}_{aa} + {T}_{ia} + {T}_{ai} + {T}_{ii} ) + {T}_{sa} \\ = K + n * {K}_{sa}\end{matrix}$$

$$( Sum of all constants are replaced by K for simplificity )$$

As such, the time complexity of this algorithm is:

$$O ( T ) = O ( K ) + O ( n * {K}_{sa} )$$

$$Approx = O ( n ) ( Since K and {K}_{sa} are constants )$$

That is, the performance overhead for the algorithm described herein is a linear equation with respect to the number of alloc_maps. Though performance can be poor for very high values of n (>100), the sizes of both alloc_map and inode_chunk (which are set at file system creation time) are calculated as a function of the file system size to avoid an impact on the performance of the algorithm. In general, the number of alloc_maps (n) need not exceed four.

For example, consider a file system of size 1 Tera Byte, alloc_map size as 1 Mega Byte and inode_chunk size as 512 kilobyte. Assuming 8 byte addresses, a single alloc_map can hold 2¹⁷ inode_chunk addresses. Even if an inode_chunk can hold just 512 inodes, a single alloc_map is sufficient to handle (2¹⁷)*(2⁹)=(2²⁶) inodes. So, using four alloc_maps (2²⁸) provides 268,435,456 inodes, which is large enough for most practical scenarios.

Although the embodiment described herein described a method for the allocation of inode tables, it is noted that the method is equally capable of de-allocating (or deleting) inodes and inode tables in a computing file system which includes multiple inode tables (i.e. a first inode table and further or additional inode tables). When a file in the file system is deleted, the corresponding inode is de-initialized by an inode de-initialization code, to thereby allow another file to use the inode. If the inode de-initializing code determines that the inode which is being de-initialized is the last remaining inode in the associated inode table, the code path de-allocates (i.e. deletes) the entire inode table and updates the associated inode map accordingly.

Embodiments of the allocation and de-allocation methods may be implemented by a computer program (in either hardware, software or a combination of the two) comprising instructions which, when implemented on a computer readable medium of a computing system, causes the computing system to implement the method steps described above.

Although not required, the computer program may be implemented via an application programming interface (API), for use by a developer, and can be implemented in code within another software application. Generally, as software applications include routines, programs, objects, components, and data files that perform or assist in the performance of particular functions, it will be understood that a software application may be distributed across a number of routines, objects and components, but achieve the same functionality as the embodiments and the broader invention claimed herein. Such variations and modifications would be within the purview of those skilled in the art.

Those of ordinary skill will appreciate that the hardware provided in the server may vary depending on the implementation. Other internal hardware may be used in addition to, or in place of, the hardware depicted in FIGS. 1 & 2. For example, included may be additional memory controllers, hard disks, tape storage devices, etc.

Furthermore, it will be understood by persons skilled in the art that the invention may be implemented in a stand alone computing device or in a distributed, networked configuration. For example, the present invention may be implemented solely or in combination in a client computing device, server computing device, personal computing device, etc.

The foregoing description of the exemplary embodiments is provided to enable any person skilled in the art to make or use the present invention. While the invention has been described with respect to particular illustrated embodiments, various modifications to these embodiments will be readily apparent to those skilled in the art, and the generic principles defined herein may be applied to other embodiments without departing from the spirit or scope of the invention. It is therefore desired that the present embodiments be considered in all respects as illustrative and not restrictive. Accordingly, the present invention is not intended to be limited to the embodiments described above but is accorded the wider scope consistent with the principles and novel features disclosed herein.

1. A method of allocating inodes in a computing file system including a first inode table, the method comprising the steps of:
determining whether all inodes in the first inode table have been initialized; and
responsive to determining that all inodes in the first inode table have been initialized, creating a further inode table allocating additional inodes.

2. A method of allocating inodes in accordance with claim 1, comprising the further step of creating at least one additional inode table when all inodes in the further inode table have been initialized.

3. A method of allocating inodes in accordance with claim 1, comprising the further step of providing one or more inode map(s), the inode map(s) pointing to a disk block address of the inode table including a selected allocated inode.

4. A method of allocating inodes in accordance with claim 3, wherein the number of inodes in each inode table is a function of a total amount of disk space and the number of inode tables addresses to be referenced in each inode map.

5. A method of allocating inodes in accordance with claim 4, comprising the further step of determining the number of inodes during file system creation.

6. A method of de-allocating inodes in a computing file system including at least a first and further inode table, comprising the steps of:
determining whether the further inode tables contains no initialized inodes; and
responsive to determining that the further table contains no initialized inodes, deleting the further inode table.

7. A method of de-allocating inodes in accordance with claim 6, comprising the further step of deleting a reference to the further inode table in an inode map associated with the further inode table.

8. A method of de-allocating inodes in accordance with claim 7, comprising the further step of:
deleting the inode map associated with the further table, in response to determining that the further table is the only table referenced by the inode map.

9. A computer program for allocating inodes in a computer file system including a first inode table, the program comprising at least one instruction which, when implemented on a computer readable medium of a computing system, causes the computing system to implement the steps of:
determining whether all inodes in the first inode table have been initialized; and
responsive to determining that all inodes in the first inode table have been initialized, creating a further inode table providing additional inodes.

10. A computer program in accordance with claim 9, arranged to implement the further step of creating at least one additional inode table when all inodes in the further inode table have been initialized.

11. A computer program in accordance with claim 9, arranged to implement the further step of providing one or more inode map(s), the inode map(s) pointing to a disk block address of the inode table including a selected allocated inode.

12. A computer program for allocating inodes in accordance with claim 11, wherein the number of inodes in each inode table is a function of a total amount of disk space and the number of inode tables addresses to be referenced in each inode map.

13. A computer program in accordance with claim 12, arranged to implement the further step of determining the number of inodes during file system creation.

14. A computer program for de-allocating inodes in a computer file system including at least a first and further inode table, the program comprising at least one instruction which, when implemented on a computer readable medium of a computing system, causes the computing system to implement the steps of:
determining whether the further inode table contains no initialized inodes; and
responsive to determining that the further inode table contains no initialized inodes, deleting the further inode table.

15. A computer program in accordance with claim 14, arranged to implement the further step of deleting a reference to the further inode table in an inode map associated with the further inode table.

16. A computer program in accordance with claim 15, arranged to implement the further step of:
deleting the inode map associated with the further table, in response to determining that the further table is the only table referenced by the inode map.

17. A computer readable medium providing a computer program product in accordance with claim 9.

18. A computer readable medium providing a computer program product in accordance with claim 14.
